(19) United States
(12) Patent Application Publication
(10) Pub. No.: US 2011/0047087 A1
(43) Pub. Date: Feb. 24, 2011

(54) System and Method for Conducting Threat and Hazard Vulnerability Assessments

(76) Inventor: Daniel Young, East Lansing, MI (US)

Correspondence Address: FOSTER, SWIFT, COLLINS & SMITH, P.C., 313 SOUTH WASHINGTON SQUARE, LANSING, MI, 48933, US

(21) Appl. No.: 12/828,749

(22) Filed: Jul. 1, 2010

Related U.S. Application Data
(60) Provisional application No. 61/222,664, filed on Jul. 2, 2009.

(51) Int. Cl. G06Q 10/00

(52) U.S. Cl. 705/317

(57) ABSTRACT

A system and method for conducting threat and hazard vulnerability assessments. The system uses a software program to conduct interviews which determine the appropriate parameters of site surveys for the facilities to be assessed and creates a customized site survey for each facility. The customized site surveys implemented using mobile computing devices that site surveyors use to record the responses to the site survey questions. The survey responses are then analyzed by the system and a vulnerability assessment report and corrective action plan are generated. The system transmits the components of the corrective action to various corrective actors that implement the corrective action plan and report their activities. The system then uses the reports from the corrective actors to determine a facility's continued vulnerability.

### CROSS REFERENCE TO RELATED APPLICATIONS

This application claims priority to U.S. provisional application Ser. No. 61/222,664, entitled “Automated System and Method for Conducting Threat and Hazard Vulnerability Assessments,” filed Jul. 2, 2009.

### FIELD OF INVENTION

The present invention relates to threat and hazard vulnerability assessments and, more particularly, to a unique system and method for conducting threat and hazard vulnerability assessments.

### DESCRIPTION OF THE PRIOR ART

Within the art of assessment of the security and safety of physical infrastructure, there is some confusion as to the proper use of terms. This is in part due to the recent popularization of terms such as “all hazards planning.” Terms such as this, have the unintended or intended effect of lumping into the term “hazard” all intentional, accidental, and natural dangers. However, experts within the art properly understand the assessment of the threat and hazard vulnerability of physical infrastructure as two related but distinct analyses.

To assess the level of a site's security, a practitioner analyzes a facility's vulnerability to threats, which are properly defined as intentional or deliberate attacks on a facility, such as a burglary. To assess the level of a site's safety, a practitioner analyzes a facility's vulnerability to hazards, or naturally occurring or accidental incidents, such as a chemical spill. A vulnerability assessment of a facility identifies the weaknesses or deficiencies in a facility's safety and security systems. For example, a threat vulnerability assessment looks for weaknesses or deficiencies in the facility's security systems, such as locks, alarms and fences, designed to become more resilient to deliberate or intentional attacks on the facility. Likewise, a hazard vulnerability assessment looks for weaknesses or deficiencies in the facility's safety systems, such as fume hoods, hand rails, and smoke detectors, designed to mitigate naturally occurring or prevent accidental incidents.

Since the events of Sep. 11, 2001, both the public and private sectors have become more concerned with the threat and hazard vulnerability of physical infrastructure. These concerns are further amplified by federal, state, and local regulation requiring physical infrastructure to meet mandatory and aspiratory standards. A facility's level of safety has been regulated for many years, most notably by the federal Occupational Safety and Health Act of 1970. This Act is designed to assure safe and healthful working conditions for working men and women; by authorizing enforcement of the standards developed under the Act. The Act also encourages the States in their efforts to assure safe and healthful working conditions. Entities in both the public and private sectors must comply with these safety regulations by conforming to statutory and regulatory requirements which are enforced through agency inspections. In the security field, the enactment of the Homeland Security Act of 2002, mandates that entities with physical infrastructure perform Security and Emergency Preparedness Assessments. These assessments must comply with the National Infrastructure Protection Plan set forth in the Act.

Legitimate threat and hazard vulnerability concerns held by both the private and public sectors, along with Congressional mandates, have prompted entities to take action. For example, many public and private entities have turned to hiring consulting firms to conduct threat and hazard vulnerability assessments. To date, threat and hazard vulnerability assessments have not been standardized and vary from one consultant to another, however, a key aspect to many threat and hazard vulnerability assessments is the site survey. A site survey is the physical inspection of a facility by a surveyor.

Traditional threat and hazard vulnerability assessment using site surveys is cumbersome because it takes a long time to plan and conduct. Surveyors must record their observations during the site surveys manually. This may or may not result in lost information or relevant information not being recorded, unobserved security vulnerabilities do to the surveyor taking notes, and other reporting errors. Once the site survey is completed, it can take months for a report to be generated. This long reporting time delays needed threat and hazard mitigation efforts. Also, a traditional threat or hazard vulnerability assessment using site surveys typically does not include photographic documentation of indentified vulnerabilities, or allow for GPS tracking of the surveys, and therefore any corrective action taken as a result of the assessment is hard to implement.

While site surveys conducted in this manner are useful for assessing the vulnerability of an entity's physical infrastructure to security breaches and safety threats, the manner in which they are currently conducted and information gathered, stored, searched, and retrieved is archaic. In light of this, many entities forgo using extensive site surveys to assess their security threat vulnerability because the site survey process is time consuming, lacks a consistent methodology, is very costly, and produces variable results that are difficult to analyze. The Applicant, however, has solved these problems by creating a system and method for conducting threat and hazard vulnerability assessments using a software program designed to quickly plan and implement site surveys for an entity's vulnerable facilities. The system allows surveyors to efficiently conduct the site surveys and is capable of facilitating the documentation of a facility's vulnerabilities using a mobile computing device that is capable of taking digital photos, recording survey answers electronically, and tracking the surveys through GPS readings. Using the software, mobile teams of surveyors can assess one or more of an entity's facilities in much less time than conducting site surveys using traditional methods. At the completion of the surveys, the software quickly generates a vulnerability assessment report showcasing all of the entity's security and/or safety weaknesses and creates a corrective action plan, which provides options that an entity might consider to decrease its vulnerability to threats or hazards. The software may then transmit the corrective action plan to the appropriate corrective actors within the entity. These corrective actors then implement the corrective action plan and report their actions. The software then may use these reports to generate a modified vulnerability assessment report to determine a facility's continued vulnerability.

The invention, at least, provides the following advances: (1) the program allows for the expedient creation of individualized, objective and customizable site surveys for use in the threat and hazard vulnerability assessments of facilities; (2) the invention allows for the administration of the individualized, objective and customizable site surveys using mobile computing devices, such as PDAs, tablet computers, or mobile phones, which reduces the hours required to complete the surveys at a tremendous cost savings to the entity; (3) the invention provides a standardized methodology that minimizes reporting errors and omissions and validates the responses received through the interview and site survey processes; (4) the invention provides a standard reporting model which allows for easy viewing and analysis; (5) the invention allows for the use of digital photography and GPS tracking to increase the accuracy of the assessment and simplify corrective measures; (6) the invention allows for a comparison of vulnerability reports generated at both like and unlike facilities; (7) the invention enables cost effective and comprehensive generation of corrective action plans that can be utilized to minimize future security and safety threats; (8) the invention allows for the efficient updating of vulnerability reports after corrective action has been taken; (9) the invention standardize and simplifies the comparison of information between like and unlike facilities, using a uniform scoring algorithm; (10) the invention allows for comparison reporting that provides information based on the most common vulnerabilities, cost of improvements, generalized comparison of scores.

Thus, there is a need, therefore, and there has never been disclosed Applicant's unique system and method for conducting threat and hazard vulnerability assessments.

### SUMMARY OF THE INVENTION

The present invention is a system and method for conducting vulnerability assessments. The system uses a software program to interview at least one test administrator on an assessment manager computing system to determine the appropriate parameters of the site survey for the facilities that will be assessed and creates a customized site survey for each of the subject facilities. Site surveyors utilize mobile computing devices to conduct site surveys and are prompted by software to examine certain aspects of the facility and to answer questions about its infrastructure. The surveyors are also prompted by the software to digitally photograph security vulnerabilities and areas of best practice that they observe. Survey responses and photographs supplied by the surveyors, are then transferred back to the test assessment management computing system for analysis. The software then assesses the data accumulated during the site surveys using a standardized scoring algorithm.

The system also uses a software program to analyze the vulnerability assessment report and determine areas of potential improvements to a facility's vulnerability. This process results in the generation of a corrective action plan, which is transmitted to the appropriate corrective actors within the entity. These corrective actors then implement the corrective action plan and report their actions. The software then uses these reports to generate a modified vulnerability assessment report to determine a facility's continued vulnerability.

### BRIEF DESCRIPTION OF THE DRAWINGS

The Description of the Preferred Embodiment will be better understood with reference to the following figures:

FIG. 1: is a diagram illustrating the computer hardware used in Applicant's system.

FIG. 2: is a flowchart illustrating the basic operation of Applicant's computer software system for generating customized site surveys, conducting those site surveys, and generating a report.

FIG. 3: is a flowchart illustrating the basic operation of Applicant's computer software system for creating and implementing a security vulnerability corrective action plan.

FIG. 4: is a diagram of the assessment management server login screen.

FIG. 5: is a diagram of the company profile screen.

FIG. 6: is a diagram of the company summary screen.

FIG. 7: is a diagram of the new user screen.

FIG. 8: is a diagram of the user report screen.

FIG. 9: is a diagram of the user summary screen.

FIG. 10: is a diagram of the facilities screen.

FIG. 11: is a diagram of the facilities report screen.

FIG. 12: is a diagram of the interview screen.

FIG. 13: is a diagram of the facility summary screen.

FIG. 14: is a diagram of the login screen on a mobile computing device.

FIG. 15: is a diagram of the facility selection screen on a mobile computing device.

FIG. 16: is a diagram of the surveyor selection screen on a mobile computing device.

FIG. 17: is a diagram of the area of assessment screen on a mobile computing device.

FIG. 18: is a diagram of the survey question screen on a mobile computing device.

FIG. 19: is a diagram of the photo screen on a mobile computing device.

FIG. 20: is a diagram of the completed site survey screen.

FIG. 21: is a diagram of the corrective action plan screen.

FIG. 22: is a diagram of the reports screen.

FIG. 23: is a diagram of the home screen.

### DETAILED DESCRIPTION OF THE PREFERRED EMBODIMENT

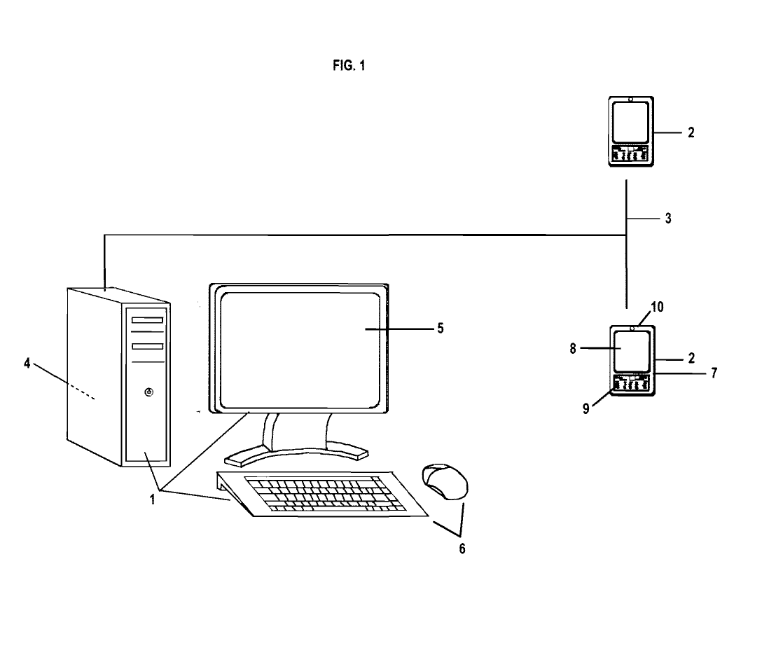

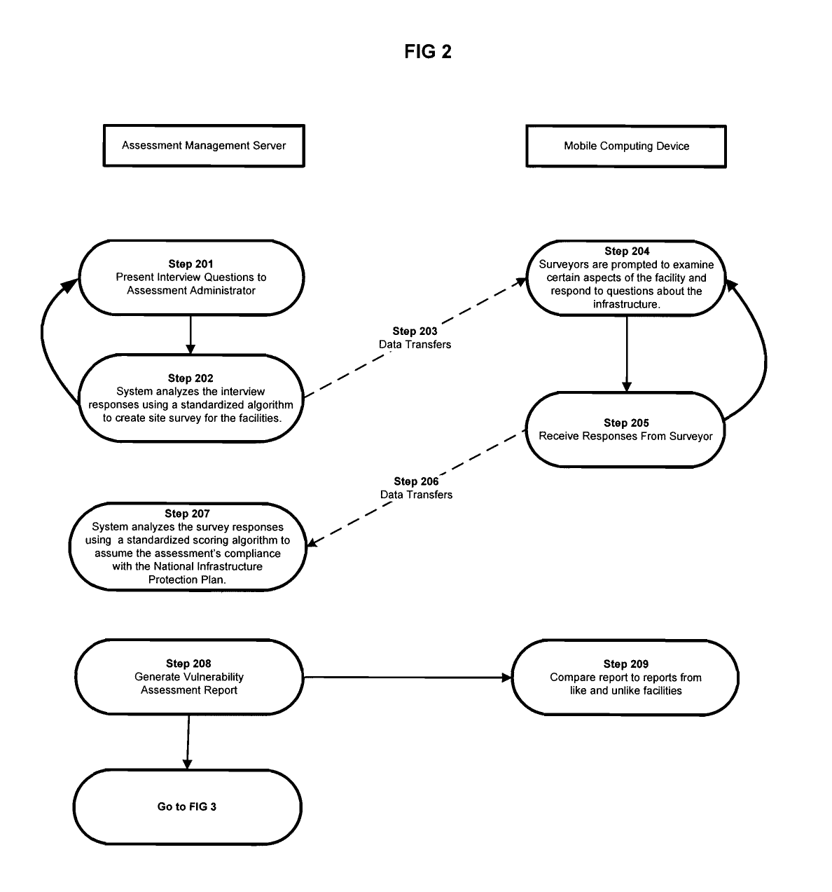

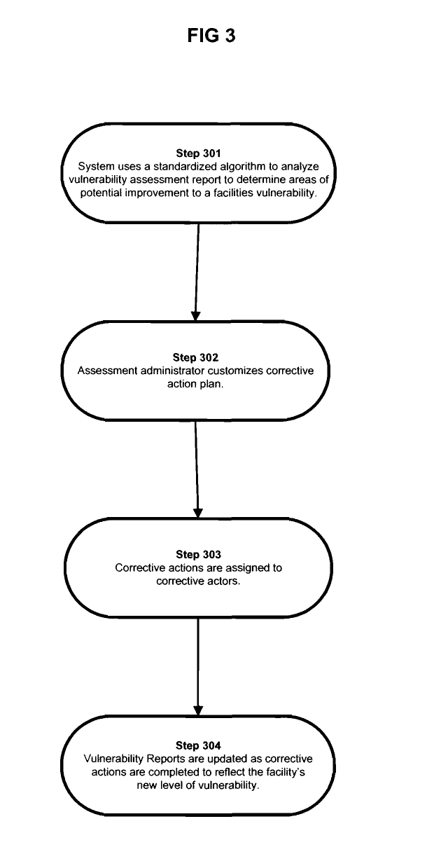

This Detailed Description of the Preferred Embodiment section will describe the invention's use in a threat vulnerability assessment. However, only slight modifications in the content of the questions presented in the interview and site survey sections of the assessment would be necessary for the system and method to be used in a hazard vulnerability assessment. Applicant's invention consists of the interaction between the computer hardware, as illustrated in FIG. 1, and the computer software as illustrated in FIGS. 2 and 3. Throughout this patent application, vulnerability assessment shall be defined as the type of assessment described in the Description of the Prior Art section above.

Turning to FIG. 1, the computer hardware consists of an assessment manager computing system 1, which may be a single computer, server, network of computers, network of servers, or any combination thereof capable of running the software application and a plurality of mobile computing devices 2, such as PDAs, tablet computers, or mobile phones. The mobile computing devices 2 may be connected to the assessment manager computing system 1 over a network connection 3 such as a local area network (LAN), a wide area network (WAN), or may be directly connected through a USB, Ethernet, or other physical networking port. The assessment manager computing system 1 must minimally consists of a central processing unit 4, a computer screen 5, and an input device 6, such as a mouse or a keyboard. The mobile computing devices 2 must minimally consist of a central processing unit 7, a screen 8, and an input device 9, such as keypad or stylus. Preferably, the mobile computing devices would incorporate touch screen input and would be equipped with digital photography capability 10. Computers, servers, computer networks, and mobile computing devices, and their components are well known in the art and it is contemplated that any compatible type, version, or size made by any manufacturer is acceptable to accomplish the intended purposes of Applicant's invention.

Preferably, to install and run the computer software on this hardware, the assessment manager 1 should provide and operating system, and available hard drive space for installation. The mobile computing devices 2 should also preferably be equipped with an operating system, and hard drive space for installation. It is contemplated that the software can be modified for use with any operating system, including but not limited to, Windows, Macintosh, Java, and Unix based systems.

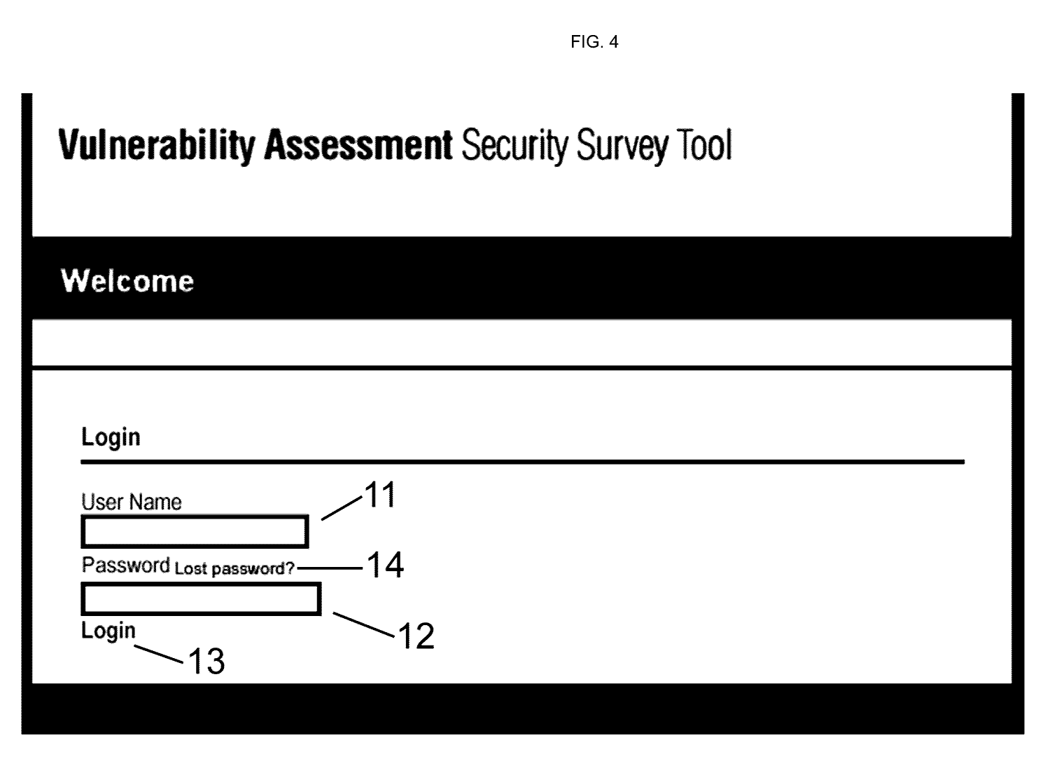

Turning to FIG. 2, there is illustrated a schematic diagram of the basic operation of a unique system and method for creating an initial vulnerability assessment report. FIG. 2 depicts steps performed on the assessment management server 1 in the left hand column and steps performed on the mobile computing devices 2 in the right hand column. Data transfers are denoted with dotted arrows. Preferably, before the test administrator may utilize the system to perform the unique method created by the applicant, he/she must login to the software application and provide certain preliminary information before beginning the assessment. When the test administrator first opens the software application on the assessment manager computer, he/she is presented with a login screen shown in FIG. 4. FIG. 4 includes a user name text box 11 into which the test administrator enters a previously assigned unique user name. FIG. 4 also includes a password text box 12 into which the test administrator enters a previously assigned unique password. Once the test administrator has entered his/her username and password into the text boxes 11 and 12, he/she may use the input device 6 to select the login icon 13. Selecting the login icon 13 after entering a valid username and password logs the test administrator into the program. If the test administrator has lost or forgotten his/her password, he/she may select the lost password icon 14, and the software will present him/her with preselected security questions. If these questions are correctly answered, the software will email the test administrator a reminder of the lost username and password.

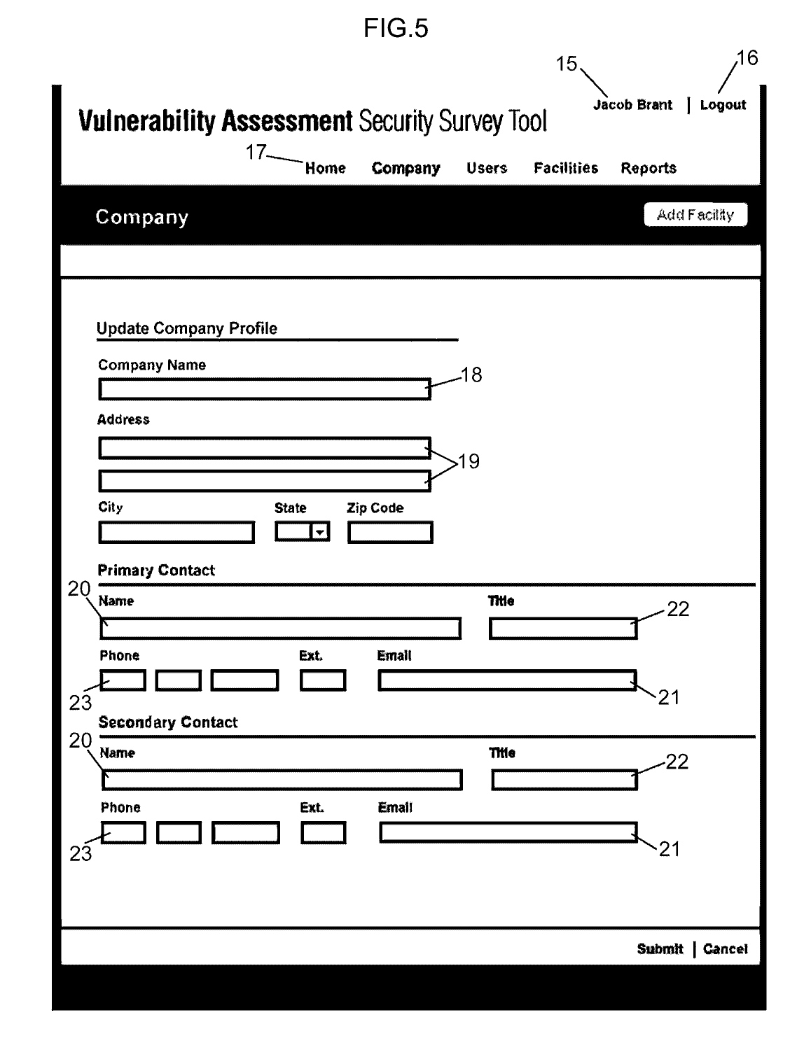

After login is complete, the test administrator is prompted by the software to enter administrative information about the company and the person performing the assessment. The test administrator is first presented with a company profile screen shown in FIG. 5. FIG. 5 includes a display of the username of the test administrator 15 that is present throughout the assessment setup and assessment process. Also present throughout the assessment setup and assessment process is a logout icon 16 which allows the test administrator to logout of the software. A title bar 17, which is system of tabs that allows the user to move between the stage screens involved in the software, is displayed on company profile screen FIG. 5 and is present throughout the assessment setup process. FIG. 5 also includes company name text box 18 and an address text box 19 into which the test administrator enters the name of the entity being assessed. The lower portion of FIG. 5 supplies text boxes to provide information about the primary and secondary contact people for the company. This information is provided by the test administrator in name text boxes 20, email address text boxes 21, title text boxes 22, and phone number text boxes 23.

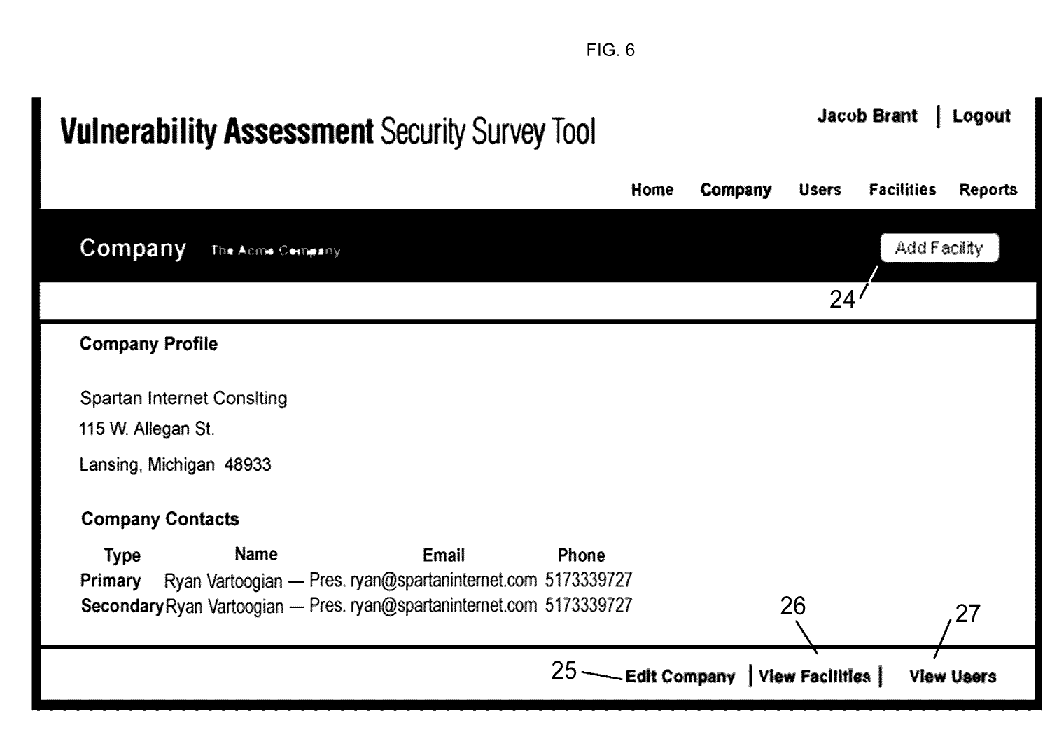

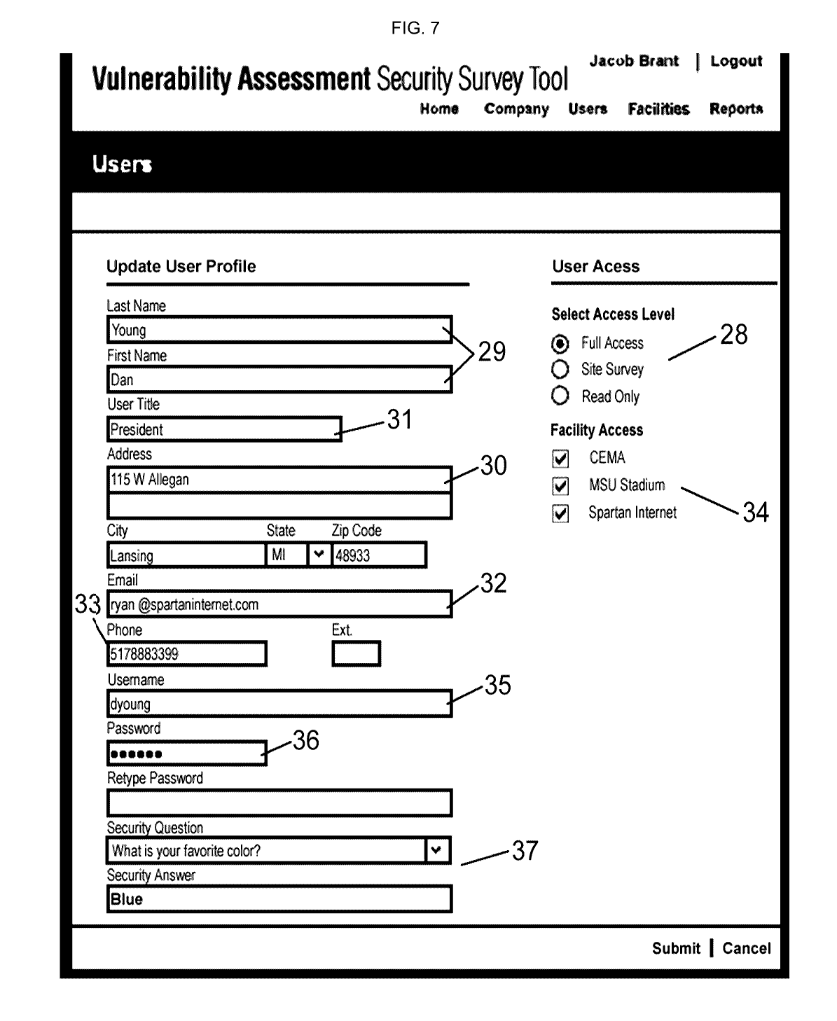

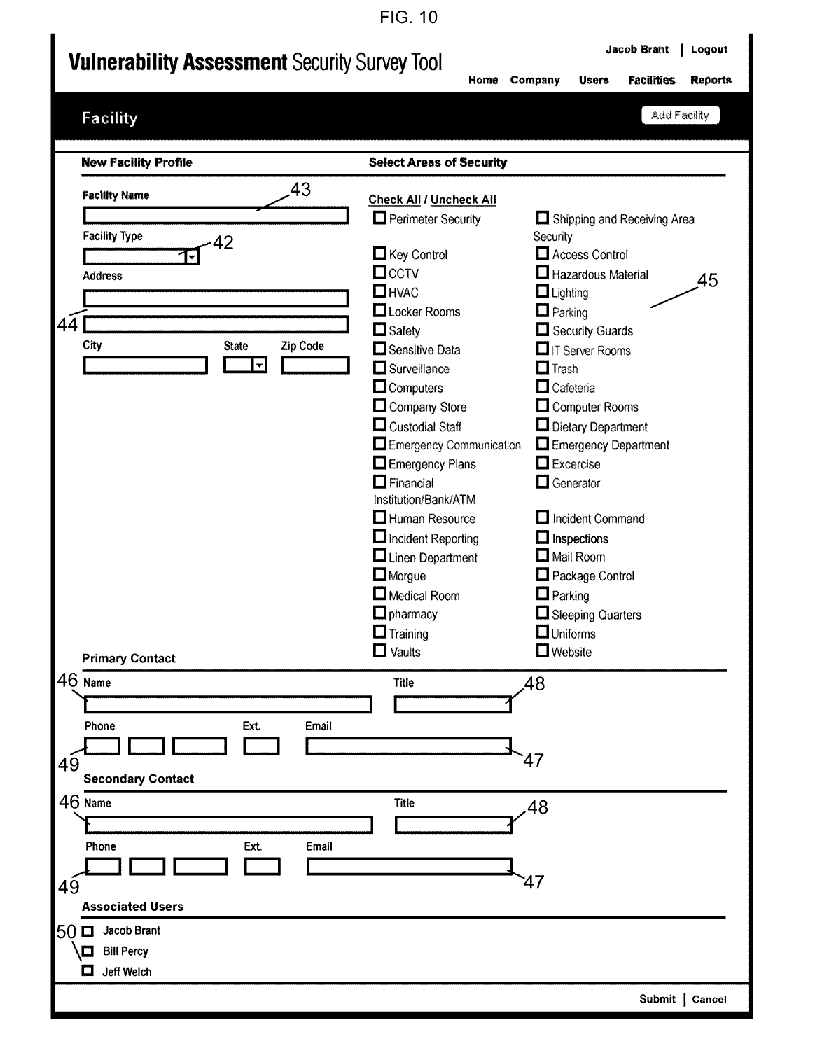

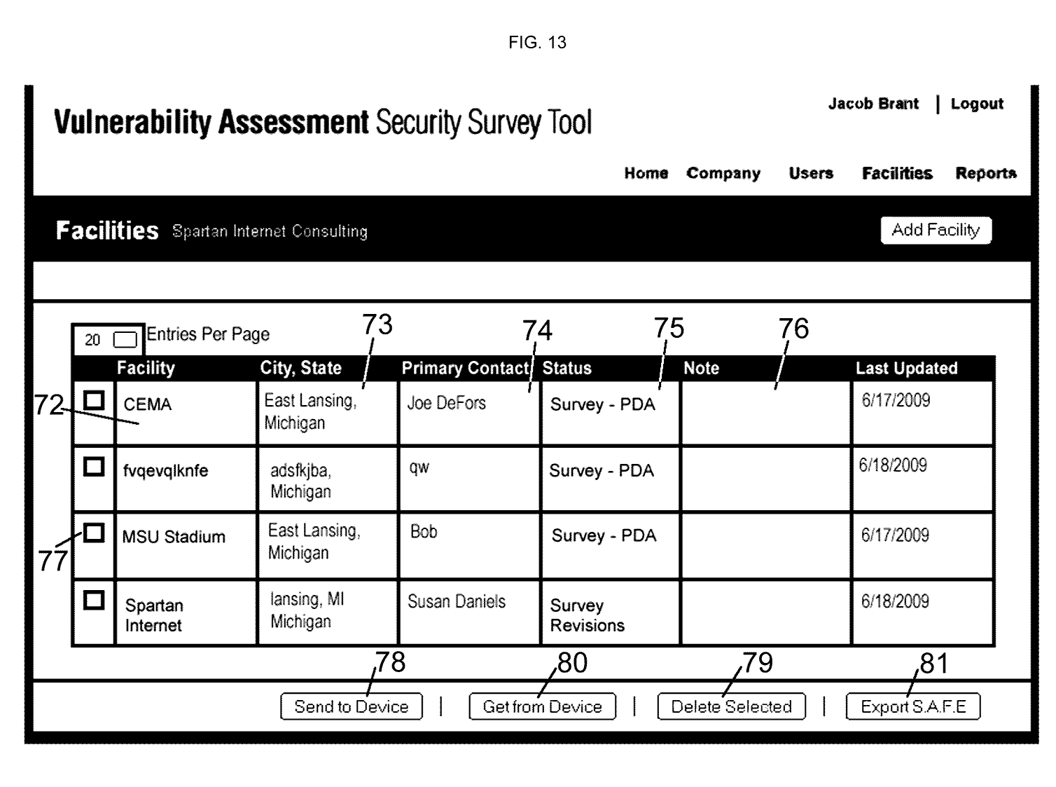

The test administrator is then presented with a company summary screen shown in FIG. 6. FIG. 6 displays a summary of the company as reported by the test administrator. If the information on this screen is satisfactory to the test administrator, he/she may select the add facility button 24 to advance to the facilities screen FIG. 10, select from the edit company button 25 to return to the company profile screen FIG. 5, select the view facilities button 26 to advance to the facilities summary screen FIG. 13, or select the view users button 27 to advance to the new user screen FIG. 7. The test administrator may choose to complete the facilities screen FIG. 10 and the new users screen FIG. 7 interchangeably.

If the test administrator chooses to select the view users button 27, he/she is presented with a new user screen shown in FIG. 7. FIG. 7 allows the test administrator to add new users to the software. The test administrator may assign users one of four distinct levels of access by designating one of the access radio buttons 28. Full access users, such as the test administrator, can access and update facility information, add users, do interviews, complete site surveys, view reports, and modify the corrective action plan. Site survey level users are only provided access to site surveys downloaded onto mobile computing devices 2. Interview level users are provided limited access to the software on the assessment manager computing system 1, which allows them to complete interviews, or a portion thereof, used to create site surveys. Reports level users are only provided access to the assessment reports. FIG. 7 supplies text boxes to provide information about the user. This information is provided by the test administrator in the first and last name text boxes 29, address text box 30, title text box 31, email test box 32, and phone number text boxes 33. The associated facility check box 34 allows the test administrator to link a user with a particular facility within the entity. The test administrator also must provide a user name and password for the new user in the user name 35 and password 36 text boxes. A security question drop down box 37 is also provided for the test administrator to provide a security question that can be used to prompt a user who forgot his/her username or password.

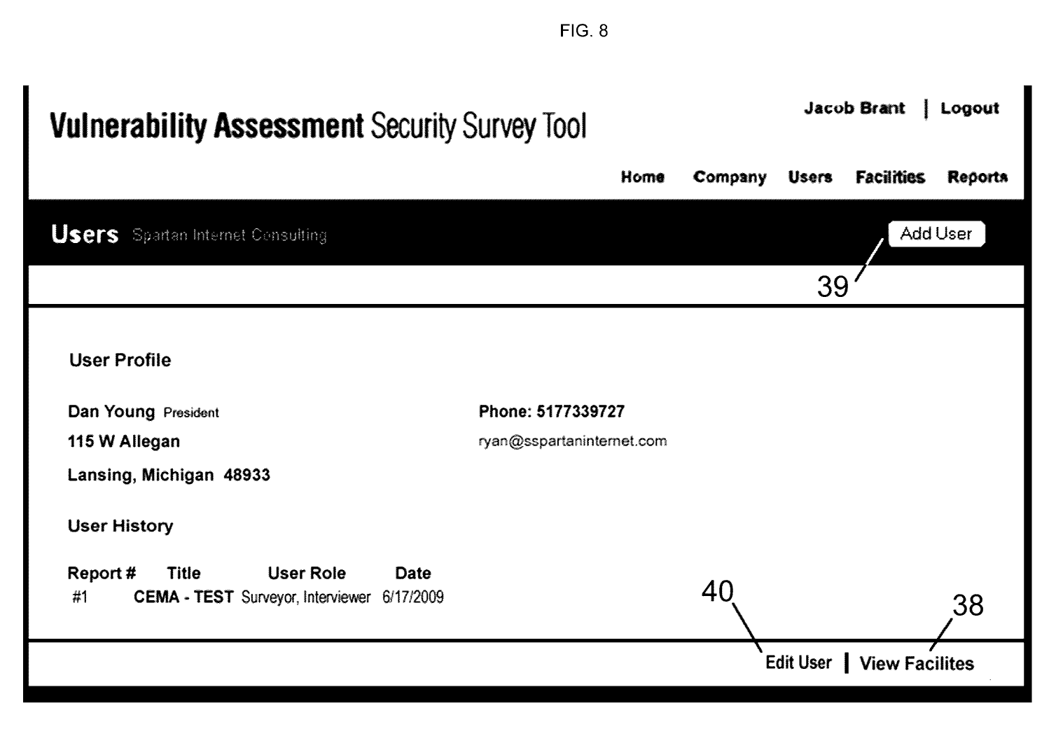

The test administrator is then presented with a user report screen shown in FIG. 8. FIG. 8 displays a summary of the users created by the test administrator. If the information on this screen is satisfactory to the test administrator, he/she may select the view facility button 38 to advance to the facilities screen FIG. 10. If the test administrator would like to add another user he/she may select the add user button 39 or if the user profile displayed contains errors he/she may select from the edit user button 40 to return to the new user screen FIG. 7.

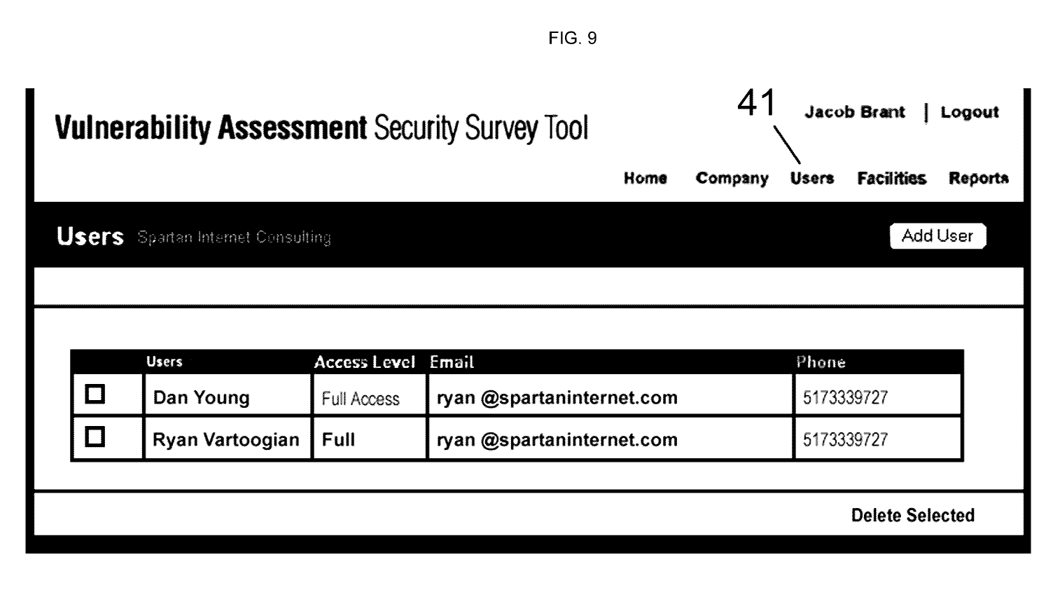

Once the test administrator has created one or more users, he/she may view with the user summary screen FIG. 9. The user summary screen FIG. 9 displays the users' names, level of access, email address, and phone number. The test administrator may access or return to this screen to add new users at any time by selecting the users tab 41 within the title bar 17.

If the test administrator chooses to select the add facilities button on the user report screen FIG. 8, he/she is presented with a facility screen as shown in FIG. 10. FIG. 10 allows the test administrator to add facilities to the software. Using a drop down menu of industry sectors 42, the test administrator may assign a facility type to the particular facility such as health care, public health, government, etc. Preferably these categories include at least the 18 categories of critical infrastructure identified by the Department of Homeland Security in the National Infrastructure Protection Plan. FIG. 10 supplies text boxes to provide further information about the facility. This information is provided by the test administrator in the facility name text box 43, and address text boxes 44 provided on FIG. 10. The areas of security check boxes 45 list the types of physical infrastructure that a facility has to assess. When the user selects one of the areas of security check boxes 45, a set of questions associated with the check box is added to the interview presented to the interview user for the facility. The lower portion of the screen FIG. 10 supplies text boxes to provide information about the primary and secondary contact people for the facility. This information is provided by the test administrator in name text boxes 46, email address text boxes 47, title text boxes 48, and phone number text boxes 49. The associated users check boxes 50 allow the test administrator to link a facility with a particular user within the entity.

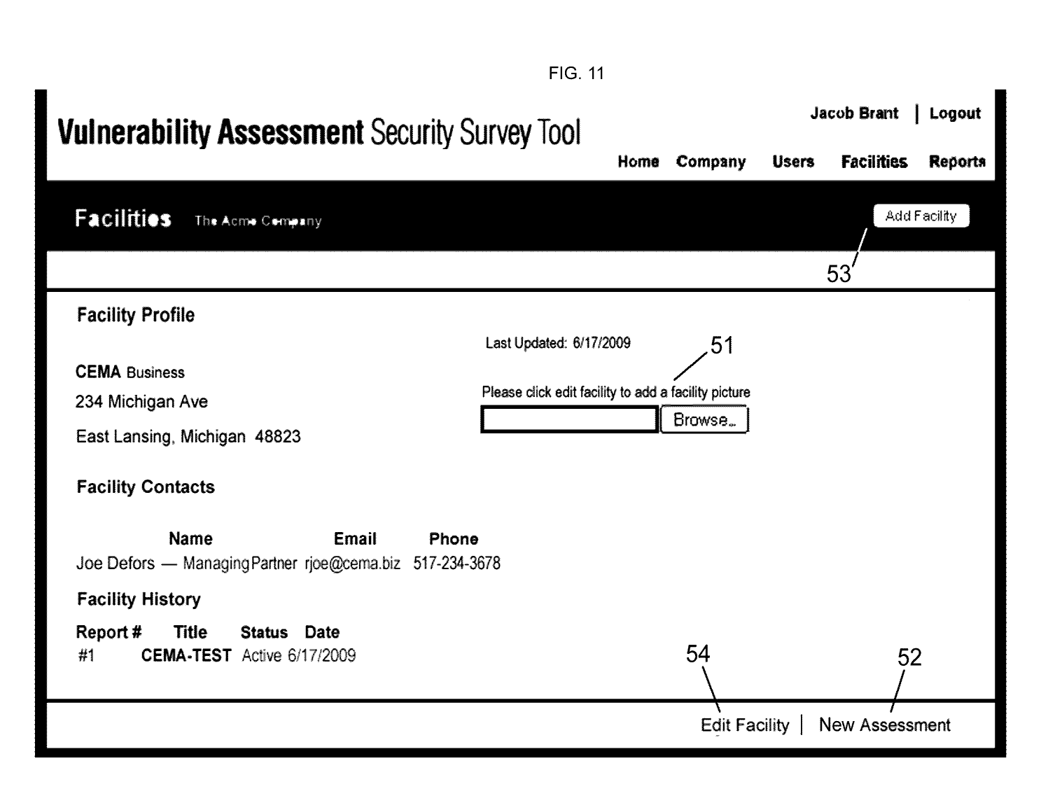

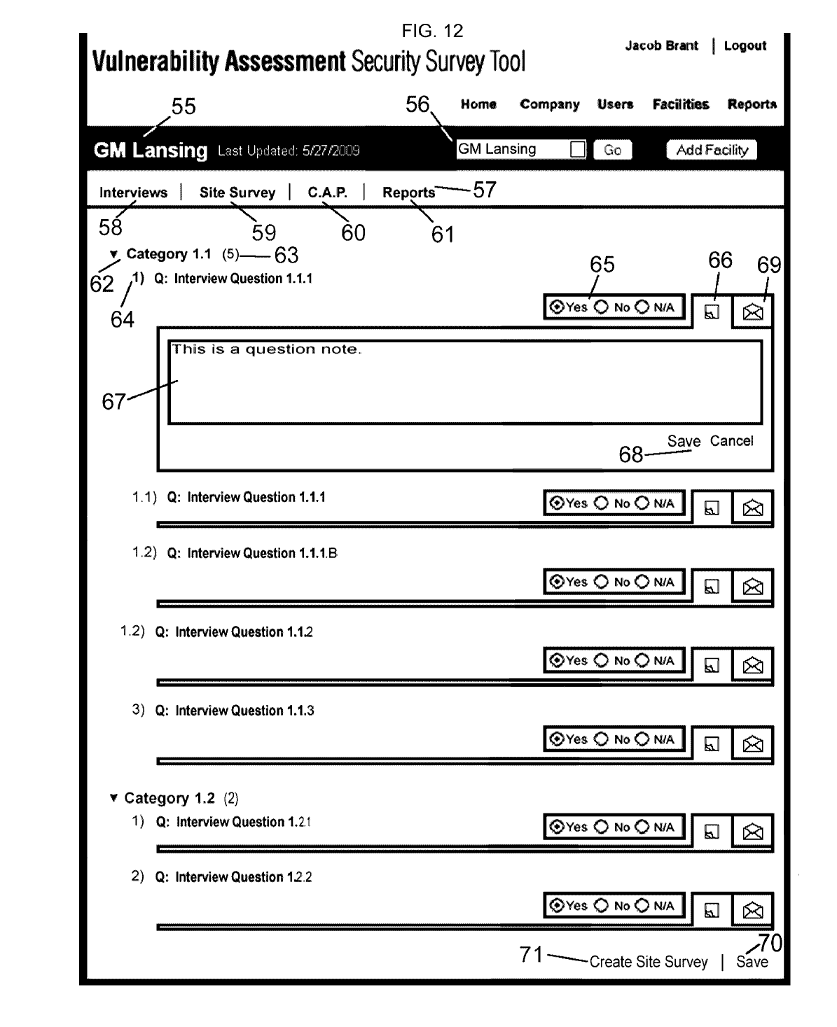

The test administrator is then presented with the facilities report screen as shown in FIG. 11. FIG. 11 provides an information summary for the newly entered facility. FIG. 11 may also provide facility history including reports previously generated by the software. A picture may be uploaded using a file browser 51 and displayed on this screen. If the information on this screen is satisfactory to the test administrator, he/she may select the new assessment button 52 to advance to the interview screen FIG. 12. If the test administrator would like to add another facility he/she may select the add facility button 53 to display the blank new facilities screen FIG. 10, or if the facility profile displayed contains errors he/she may select from the edit facility button 54 to return to the new facility screen FIG. 10 he/she has previously worked on.

If the test administrator chooses to select the new assessment button on the facilities report screen FIG. 11, he/she is presented with the interview screen as shown in FIG. 12. At this point the test administrator or another user with interview or full level access hereinafter referred to as the interview user, may begin to perform Step 201. In Step 201, the interview user is asked to respond to a series of questions so that the software may determine the appropriate parameters of the site survey for the facilities to be assessed. The interview screen FIG. 12 contains a facility title 55 which shows the interview user the facility he/she is being asked to provide information. A drop down menu 56 allows the interview user to switch the facility about which the user is being interviewed. The interview screen FIG. 12 also contains a new title bar 57 which contains interviews 58, the survey 59, C.A.P. 60, and reports 61 tabs, which allow the user to move between the stage screens involved in the assessment portion of the software.

The category title 62 corresponds with the areas of security check boxes 45 on FIG. 10 and also provides the interview user with the number of interview questions in the category 63. The interview screen FIG. 12 presents the test administrator with a series of textually based interview questions 64. The interview user answers these questions 64 by selecting either the “yes,” “no,” or “N/A” radio buttons 65 on the right side of the screen FIG. 12. The software system will analyze the response and will generate additional sub-questions to gather more information. The note icon 66 brings down note text box 67 where the interview user may supply additional information in narrative form such as “we don't have badge system but will implement one on Aug. 1, 2009.” The save and cancel buttons 68 below note text box 67 save or delete the note. The email icon 69 allows the interview user to email the question to an appropriate individual within the entity for an answer. As the interview user provides answers to the interview questions the software may present the interview user with additional questions to follow up on the interview user's responses. The save button 70 allows the interview user to save his/her answers at any point during the interview process, Step 201. Once the interview user has completed all the questions presented by the software, the interview user may select the create site survey icon 71 to proceed to a site survey screen as shown in FIG. 13.

Once the interview user has completed all the interview questions and has selected the create site survey icon 71, the system automatically performs Step 202. In Step 202, the system analyzes the interview users' responses using a standardized algorithm to create site surveys for the facilities. The test administrator may then perform Step 203. In Step 203, the customized site surveys are transferred to a plurality of mobile computing devices 2, which are used by site surveyors. This transfer is facilitated by the facilities summary screen FIG. 13. This screen FIG. 13 displays the names of the facilities 72, the facilities' addresses 73, the primary contact for the facilities 74, the current status of the assessment at that facility 75, notes on the facilities' status 76, and the date that the facilities' assessment was last updated. A facilities' status 75 tells the interview user what part of the assessment process the facility is currently involved in and allows the interview user to monitor the status of the assessment at each facility throughout the entity. Status notes 76 may only be provided by a full access user such as the test administrator. Notes 76 further detail the status of the assessment at the entity's facilities. Check boxes 77 allow for the interview user selection of one or more facilities. When a user checks a facility, the checked facility becomes subject to the user's next command. The user may select the send to device button 78 to send the site survey generated by the system to the mobile computing device 2. Alternatively, the delete selected button 79 allows a user to delete a site survey generated by the system Step 202 and remove a facility from the facilities summary screen FIG. 13. The get from device button 80 allows the test administrator to download completed site surveys from the mobile computing devices 2 to the assessment management server 1.

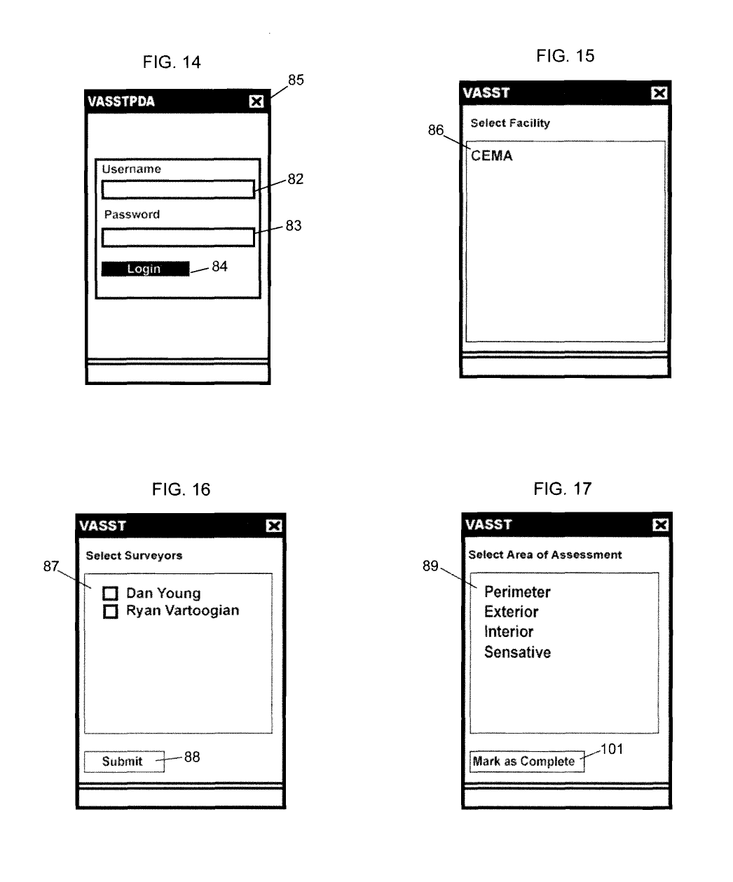

Once the customized site surveys have been transferred to the mobile computing devices 2, the site surveyors perform step 204. In Step 204, the site surveyors are prompted by the software to examine certain aspects of the facility and to answer text based questions about the infrastructure. The software will also prompt the site surveyors to digitally photograph certain security vulnerabilities that they observe. When a site surveyor first opens the software application on a mobile computing device 2, he/she is presented with a login screen as shown FIG. 14. Only full access users or users with site survey level access will be able to login to the site survey application on a mobile computing device 2. The login screen FIG. 14 includes a user name text box 82 into which the site surveyor enters a previously assigned unique user name. A password text box 83 is also provided into which a site surveyor must enter his/her previously assigned unique password. Once the test administrator has entered his/her username 82 and password 83 into the text boxes he/she may use the input device 9 to select the login icon 84. Selecting the login icon 84 after entering a valid username and password logs the site surveyor into the site survey application on the mobile computing device 2. At any time a site surveyor may close the site survey application on the mobile computing device 2 by selecting the x button 85 in upper right hand corner of the login screen FIG. 14. In all subsequent site survey screens the x button 85 allows the surveyor to quickly return to the previous screen.

After login is complete, the site surveyor is presented with a company facility selection screen as shown in FIG. 15. FIG. 15 allows the site surveyor to select, using an input device 9, from the available site surveys 86 downloaded to the particular mobile computing device 2. Once the site surveyor has selected a site survey, the site surveyor is presented with a surveyor selection screen as shown in FIG. 16. Check boxes 87 allow the site surveyor to select other team members that may be involved in supplying the survey responses recorded on the particular mobile computing device 2. Once the other team members, if any, are selected the submit button 88 advances the program to the area of assessment screen FIG. 17. FIG. 17 allows the surveyor to select the area of the facility 89 such as the perimeter, exterior, etc., that he/she is currently assessing. To complete the survey, a site surveyor must survey all the areas presented by the software but may do so in any order selected by the surveyor.

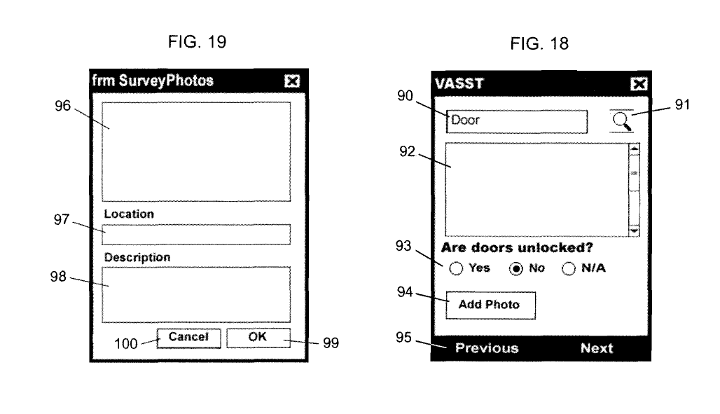

Once the site surveyor has selected the area of the facility to be assessed, the site surveyors may perform step 205. The site surveyor is presented with a survey question screen as shown FIG. 18. FIG. 18 displays a question category search box 90. When the surveyor inputs a keyword into the question keyword search box 90 and selects the search button 91, a series of questions appears in text box 92. When the site surveyor selects a question from the series the question will appears below box 92. Below the selected question the “Yes,” “No,” or “N/A” radio buttons 93 appear at bottom of the screen which allows surveyor to log his/her response to the questions presented in the text box 92. If surveyor answer is deficient, the add photo button 94 appears and the surveyor may select the add photo button 94 to bring up the photo application on the mobile computing device. The previous/next tool bar 95 allows the surveyor to return to a previously asked question or advance the site survey application to the next unanswered question.

When a surveyor takes a photograph using the mobile computing device's photo application, a photo screen as shown in FIG. 19 appears. The photograph is displayed in the photograph window 96. The location text box 97 allows the surveyor to manually enter a description of the location of the vulnerability or GPS coordinates for the location of the photograph if the mobile computing device 2 on which he/she is working is not capable of automatically presenting GPS coordinates in the location text box 97. The description text box 98 allows the surveyor to enter a narrative description of the defect. The OK button 99 allows the surveyor to save the text and photograph and return to survey question screen FIG. 18. The cancel button 100 allows the surveyor to return the survey question screen FIG. 18 but does not save the photograph or any text entered.

After a surveyor has completed a series of questions within a question category, the software application returns the surveyor to the assessment screen FIG. 17. After the surveyor has answered every applicable question category for each area of the facility the surveyor selects the mark as complete button 101. The mark as complete button 101, saves the completed site survey and prepares the results for download to the assessment management server 1.

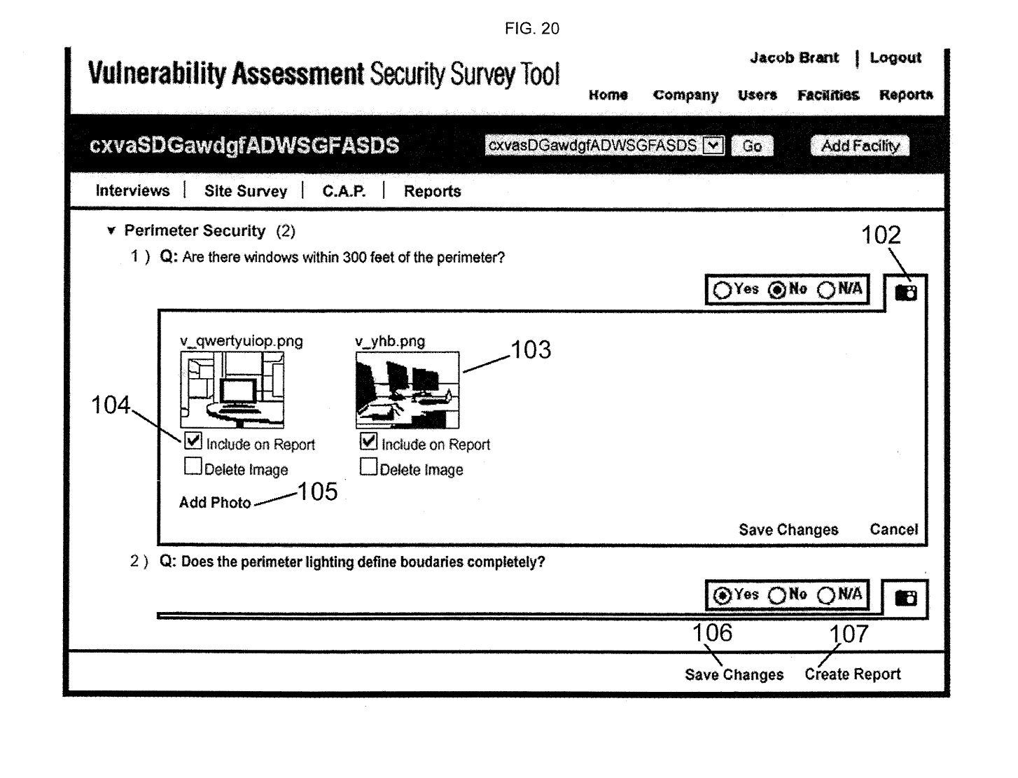

In Step 206, survey responses and digital photographs supplied by the surveyors are transferred from the mobile computing devices 2 to the test assessment manager computing system 1 for analysis. To prepare for download of the competed site surveys, the assessment administrator directs the software on the assessment management server 1 to the facilities summary screen FIG. 13. To download the completed site survey, the assessment administrator checks the facility box 77 and selects the get from device button 80. Once the competed site survey has been downloaded the software directs the assessment administrator to a display of a competed site survey as shown in FIG. 20. On FIG. 20, Camera icons 102 allow the assessment administrator to display the pictures 103 taken by the site surveyors that are associated with a particular question. For each picture 103 displayed, the assessment administrator is presented with check boxes 104 inquiring as to whether to include the image in the report or delete the image. The add photo icon 105 allows the assessment administrator to add a photo received from a source other than the site surveyor, such as by email from personnel not involved in the site survey, to the assessment report. The save changes icon 106 allows the assessment administrator to save his/her work and advance to the next question. Assessment administrator may select the create report icon 107 once he/she has finished editing and refining the raw answers to the site survey questions. Once the create report icon 107 is selected, the software performs step 207. In step 207, the software assesses the data accumulated during the site surveys using a standardized scoring algorithm. The system then automatically performs step 208, in which the system then generates a vulnerability assessment report. Reports are preferably generated in html or other similar format that may be printed or emailed by the assessment administrator for ease of distribution.

Optionally, in Step 209, the report may be compared to reports from other like and unlike facilities. The export to safe button 81 displayed on FIG. 13 allows for the transport of the report data to an external source using an encrypted file format to be compared with the raw data from other like and unlike facilities. For example, if an entity is a hospital, its scores would be compared to those received by other hospitals, as well as unlike facilities with similar physical infrastructure, for example, alarm systems.

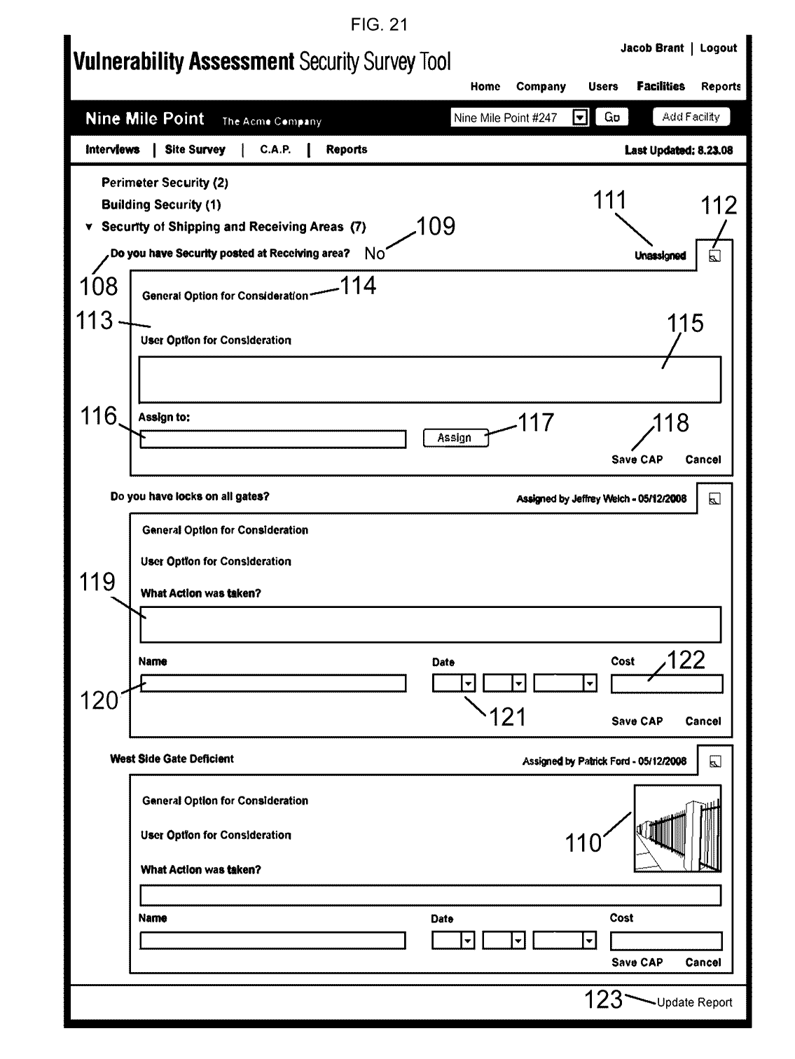

Turning to FIG. 3, there is illustrated a schematic diagram of the basic operation of a unique system and method for utilizing the vulnerability assessment report to create and implement a corrective action plan. In Step 301, the system uses a standardized algorithm to analyze the vulnerability assessment report to determine areas of potential improvements to a facility's vulnerability. Once the report is generated step 208, the software presents the assessment administrator with a corrective action plan screen as shown in FIG. 21. FIG. 21 lists the deficiencies identified in both the interview and the site surveys. Deficiencies are labeled by stating the question posed by the site survey 108 along with the deficient answer 109. Pictures included in the report 110 are also displayed. The assigned or unassigned icon 111 tells the user whether the deficiency has been assigned to a corrective actor for corrective action. The note icon 112, when selected, opens the options for consideration window 113. In this window 113 the software provides general options for consideration 114 which may be implemented by the entity to remedy the deficiency, for example, replace a burned out light.

In Step 302, the assessment administrator may customize the corrective action plan, by adding further corrective actions not generated by the software. The user options for consideration text box 115 on the corrective action plan screen FIG. 21 allows the assessment administrator to enter specific instructions on how a corrective actor should remedy the deficiency. In Step 303, corrective actions are assigned corrective actors within the entity. The assign to text box 116 displayed on the corrective action plan screen FIG. 21 allows the assessment administrator to enter the name of the appropriate corrective actor to which the remedy of the deficiency should be assigned, for example Joe Smith in maintenance. The assign button 117 emails the information in the options for consideration window 113 to the assigned corrective actor. The save CAP button 118 allows assessment administrator to save his/her work on the corrective action plan.

In Step 304, the vulnerability assessment report is updated as corrective actions are completed. When the assessment administrator receives feedback from a corrective actor about the corrective action the entity has taken he/she enters this information into the what action was taken text box 119. The name text box 120 allows the assessment administrator to input of the name of the corrective actor that performed the corrective action. The date drop boxes 121 allow for the input of the date that the corrective action was completed. The cost text box 122 allows for the entry of the total cost to the entity for the corrective action taken. Once the assessment administrator has entered information about the corrective action he/she selects the update report button 123 which instructs the software to perform step 304 by updating the vulnerability report to account for any corrective action that the entity has taken. Optionally, the user may direct the system to perform step 209, to compare the modified report to reposts from other like and unlike facilities. To do so, the use selects the export to safe button 81 displayed on FIG. 13.

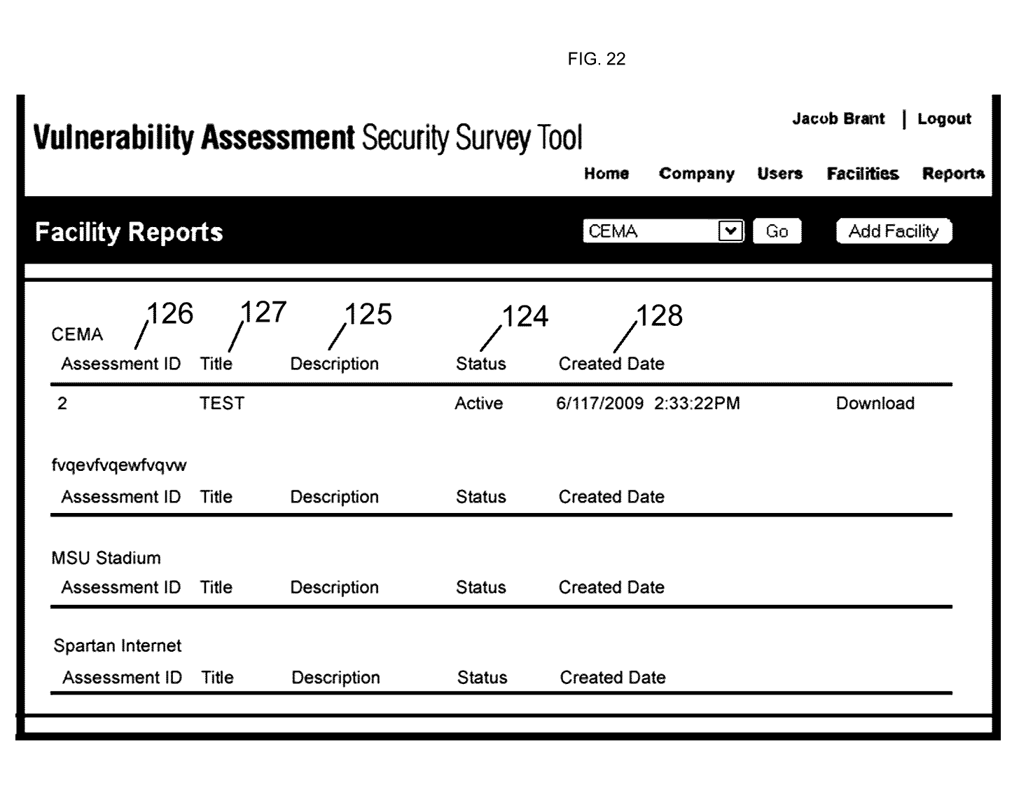

After an entity has completed at least one vulnerability assessment for at least one facility, the assessment administrator may access a reports screen as shown in FIG. 22. FIG. 22 lists all the reports generated for an entity. The status column 124 displays the status of a particular assessment. An active assessment is one that is the most recent for a facility and could still be utilized for a corrective action plan. An archived report is an historical report that would no longer be used for corrective action plans but would be useful in showing vulnerability trends over time. The description column 125 allows the assessment administrator to enter further information about the report. The assessment ID column 126 provides the ID number that the software has assigned to the assessment. The title column 127 provides the title that assessment administrator assigned to the assessment. The date created column 128 provides the date on which the report was last modified.

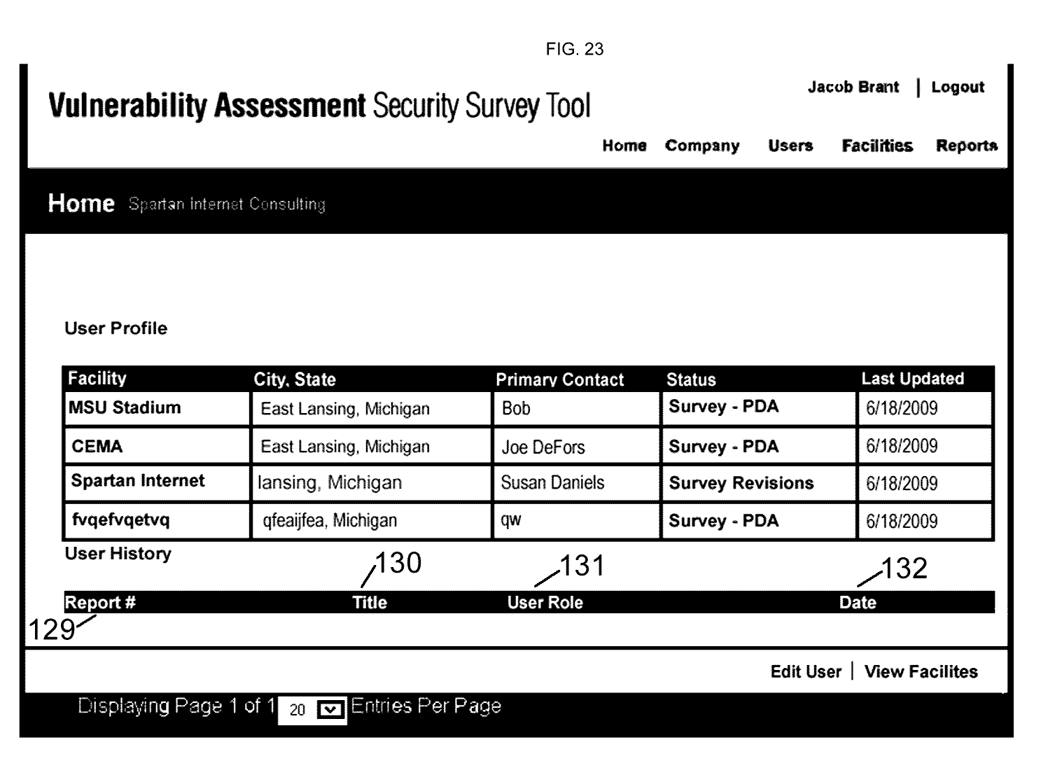

After the software has been initially used to conduct assessments, each successive time a user logs into the software on the assessment management server they are presented with the home screen FIG. 23. The home screen FIG. 23 is specific to the logged in user but generally lists company facilities as facilities summary screen FIG. 13, but additionally displays completed reports 129 on which the logged in user has participated. The title column 130 provides the title that assessment administrator may assign to the report. The user role column 131 states whether user was the assessment administrator, performed the interview, or conducted a site survey. The date column 132 provides the date on which the report was last modified.

Thus, there has been provided a unique system and method for conducting threat and hazard vulnerability assessments. While the invention has been described in conjunction with a specific embodiment, it is evident that in many alternatives, modifications and variations will be apparent to those skilled in the art in light of the foregoing description. Accordingly, it is intended to embrace all such alternatives, modifications and variations as fall within the spirit and scope of the invention.

What is claimed is:

1. A method for administering a vulnerability assessment, comprising the steps of:
using an assessment management computing system to conduct interviews of at least one interview user;
analyzing interview responses to create site surveys;
assessing facilities using a plurality of site surveyors to implement a plurality of site surveys;
analyzing the results of a plurality of site surveys; and
generating a vulnerability assessment report.

2. The method according to claim 1, wherein implementing the site surveys comprising the steps of:
transferring a plurality of site surveys from the assessment management computing system to a plurality of mobile computing devices;
conducting the site survey by having a plurality of site surveyors answer questions posed by the site surveys on mobile computing devices; and
transferring data from a plurality of completed site surveys on a plurality of mobile computing devices to the assessment management computing system.

3. The method according to claim 2, wherein implementing the site surveys further comprising the step of:
collecting photographs of at least one facility.

4. The method according to claim 1, further comprising the steps of:
analyzing a vulnerability assessment report to determine areas of potential improvements to a facility's vulnerability;
generating a corrective action plan;
transmitting the corrective action plan to a plurality of corrective actors; and
modifying the facilities using a plurality of corrective actors to implement the corrective action plan.

5. The method according to claim 4, further comprising the steps of:
capturing data from a plurality of corrective actors;
analyzing data from a plurality of corrective actors to determine areas of a facility's continued vulnerability; and
generating a modified vulnerability assessment report to determine a facility's continued vulnerability.

6. The method according to claim 5, further comprising the step of:
comparing the vulnerability assessment report to reports from other like and unlike facilities.

7. The method according to claim 6, wherein comparing the vulnerability assessment report to reports from other like and unlike facilities includes tracking vulnerabilities at facilities over time.

8. A computer based method for implementing a security vulnerability corrective action plan, comprising the steps of:
analyzing a vulnerability assessment report to determine areas of potential improvements to a facility's vulnerability;
generating a corrective action plan;
transmitting the corrective action plan to a plurality of corrective actors; and
modifying the subject facilities using a plurality of corrective actors to implement the corrective action plan.

9. The method according to claim 8, and further comprising the steps of:
capturing data from a plurality corrective actors;
analyzing data from a plurality of corrective actors to determine areas of a facility's continued vulnerability; and
generating a modified vulnerability assessment report to determine a facility's continued vulnerability.

10. The method according to claim 9, and further comprising the step of:
comparing the vulnerability assessment report to reports from other like and unlike facilities.

11. The method according to claim 10, wherein comparing the vulnerability assessment report to reports from other like and unlike facilities includes tracking vulnerabilities at facilities over time.

12. The method according to claim 8, wherein one of the plurality of corrective actors is an entity's personnel.

13. The method according to claim 8, wherein transferring the corrective action plan to a plurality of corrective actors further comprises sending the corrective action alert to the corrective actors electronically.

14. A computer system programmed to administer a vulnerability assessment comprising:
a computer configured to present a plurality of questions to a plurality of test administrators;
the computer further configured to analyze the answers provided by the plurality of test administrators to generate individual site surveys;
a plurality of mobile computing devices configured to administer a plurality of site surveys;
the mobile computing devices further configured to capture data from a plurality of input streams resulting from the administered site surveys;
a computer configured to compile the results of a plurality of administered site surveys recorded on the plurality of mobile computing devices; and
a computer configured to analyze the results of a plurality of administered site surveys to generate a vulnerability assessment report.

15. The computer system according to claim 14, wherein the results of a plurality of administered site surveys are analyzed using a weighted scoring algorithm.

16. The computer system according to claim 14, wherein the plurality of selected questions presented to the plurality of test administrators are text based questions displayed on a computer screen attached to a computer.

17. The computer system according to claim 14, wherein the plurality of site surveys are presented on a plurality of mobile computing devices as text based questions displayed on a screen attached to the mobile computing device.

18. The computer system according to claim 14, wherein one of a plurality of input streams resulting from the administered site surveys is digital photography.

19. The computer system according to claim 14, wherein one of a plurality of input streams resulting from the administered site surveys is the answers to text based questions displayed on a screen attached to a mobile computer.

20. A computer system programmed to implement a security vulnerability corrective action plan comprising:
a first computer configured to analyze a vulnerability assessment report to determine areas of improvement to a facility's vulnerability and generate a corrective action plan;
the computer further configured to transmit a plurality of corrective actions to a plurality of corrective actors;
the computer further configured to capture data from a plurality of corrective actors; and
the computer further configured to generate a modified vulnerability assessment report to determine a facility's continued vulnerability.

21. The computer system according to claim 20, further comprising:
a computer configured to capture data from a plurality of corrective actors;
the computer further configured to analyze data from a plurality of corrective actors to determine areas of a facility's continued vulnerability;
the computer further configured to generate a modified vulnerability assessment report to determine a facility's continued vulnerability.

22. The computer system according to claim 21, further comprising:
a computer configured to compare the vulnerability assessment report to reports from other like and unlike facilities.

23. The computer system according to claim 22, wherein comparing the vulnerability assessment report to reports from other like and unlike facilities includes tracking vulnerabilities at facilities over time.

24. The computer system according to claim 20, wherein one of the plurality of corrective actors is the facility's personnel.

25. The computer system according to claim 20, wherein a computer code device is configured to transmit a plurality of corrective action plans to a plurality of corrective actors by sending the corrective action plain to the corrective actors electronically.
